(19) United States
(12) Patent Application Publication
(10) Pub. No.: US 2016/0116085 A1
(43) Pub. Date: Apr. 28, 2016

(54) Nolte Threaded Cube Support Fastener

(71) Applicant: Jimmy Maurice Shiner, JR., Leesburg, FL (US)

(72) Inventor: Jimmy Maurice Shiner, JR., Leesburg, FL (US)

(21) Appl. No.: 14/512,468

(22) Filed: Oct. 13, 2014

(51) Int. Cl. F16L 3/22

(52) U.S. Cl. CPC F16L 3/22

(57) ABSTRACT

An apparatus including a cubed shaped attachment device used to provide a means of attachment to preexisting threaded rod configurations employed in the field of construction, and a method of securing conduit devices. The cubed shape attachment hardware permits additional raceways, conduits and support structures to quickly be added to preexisting configurations without the need of disassembling, or reassembling of the pre-existing conduit hardware. The cubed hardware device is employed either having a hinge or non-hinged attachment, permitting its quick installation at any point of the threaded rod.

### FIELD OF INVENTION

The present invention is directed towards specialized construction hardware used in the installation, attachment, and securing of threaded hardware applications used in construction including mechanical, electrical, and plumbing rack systems.

### BACKGROUND OF INVENTION

During the construction process building contractors are responsible for installing and providing the proper support systems used for wiring and plumbing. These support systems are important because they provide the avenue for channeling wiring and plumbing structures safely from one location to the other. Hardware devices called raceways and conduits are integral parts of this distribution system. Raceways and conduits can be constructed of metal or ceramic materials. Raceways are basically, passageways that provide an unobstructed avenue for electrical wiring, plumbing or tubing to safely pass. An advantage of installing metallic or ceramic raceways during construction is that they remain for the life of the structure and in many cases can be expanded to accommodate future additional wiring or plumbing.

However problems arise in the construction process when an additional conduit is needed to expand a preexisting mechanical, electrical or plumbing conduit. Unfortunately the way to add additional conduits is by disassembling the existing rack mounted device and then expanding it so that it can accommodate the new conduit. It is a labor intensive process.

Henceforth, because of the weight and distance traveled, raceways and conduits require support structures and a means of attaching these support structures to them. The support structure most often used are threaded metallic rods. Threaded metallic rods require a means of attachment to secure distribution systems. A typical support structure utilizes a pair of threaded rods which are attached vertically with nuts that are attached therewith having multiple horizontal channel members forming what is referred to in the industry as a trapeze-type support system. These horizontal channel members typically use racks, conduits, or metallic/ceramic raceways to provide the means of directing the electrical and plumbing lines.

Once the determination is made of where the wiring and plumbing channels are to be used, contractors begin installing their respective support structures. This is tedious work and is done by hand. The channel members carrying the conduit devices are then attached in multiple parallel locations on the threaded rods. They are spaced apart from one another by first manipulating in order; a nut, lock washer and a square washer above each channel member and immediately below the channel member in reverse order; a square washer, a lock washer and a nut. The nuts are threaded by hand onto each threaded rod until the channel members are at their desired position (height) of the threaded rod, Sometimes multiple channel members are used, requiring positioning them at various heights of the threaded rods to provide additional levels of a channeling means, Once the metal framing system has been assembled through the process of manually rotating each nut, lock washer and a square washer, the threaded rods are then attached to the ceiling of the building and hang vertically to the desired height. The conduits and other structures can know rest on the channel members.

This is a highly labor-intensive process whereby the hardware consisting of the nuts and washers are threaded by hand from each end of the threaded rod up to their desired positions. The manual manipulation of a washer, square washer and channel members require careful measuring and proper positioning. Some threaded rods can be as long as 8-10 feet, requiring a great deal of work to properly position the channeling means. When multiple channels are needed this process has to be repeated for each desired channel member to the threaded rods,

It should be noted that U.S. Pat. No. 8,511,623 B1 by the inventor of this application is hereby incorporated by reference in its entirety.

What is a needed in the field is for a means of quickly attaching conduit devices to preinstalled threaded rods without the need of detaching the support members and hardware from their preexisting configuration.

### SUMMARY OF INVENTION

The present invention overcomes the deficiencies of the known art and the problems that remain unsolved by providing a method of attaching additional channels, including multiple leveled channels to any preexisting fastening support system without requiring the disassembly of the rack mounted devices.

Many times contractors have existing strut rack raceways and want to add conduits to the existing all-threaded strut racks. The current methodology is to dissemble the strut racks, and conduits, then adding additional pieces of strut before reassembling. The proposed fastener allows the addition of multiple conduits to any pre existing fastening support systems without disassembly.

The proposed invention may be of any size but industry standard sizing is desirable. A cube called a Nolt, composed of two equally symmetric parts, used in the construction of buildings, is created from but not limited to a mold, hard plastic or solid machined material. It is cut in half, drilled and tapered throughout the center on opposing sides. The cube is not limited to but may be constructed of hard or soft polymers such as polyurethane, metals, or molding materials. This creates a continuous threaded interior from end to end on two portions. Any material can be utilized (e.g. plastic, acrylic aluminum, stainless steel,) as long as the material is of a “taperable” material. The cube will have attached to each half a hinge fastener not limited but secured by at least four screws that are not limited to but may be in length of ⅜ of an inch. The cube may have four 6/32×¾ inch screws that secure the fastener. The cube has no minimum or maximum size. The all thread also has no minimum or maximum size. The hinge is not limited to a minimum or maximum size. As the all-thread increases in size, the cube's size will increase as will the hinge attachment and the screws that secure the fastener.

The hinge is not limited to but may be fastened in any industry standard manner, such as welded, molded, glued, or screwed. The hardware will install on all existing all-thread applications and includes any mechanical, electrical, and or plumbing strut rack system.

There is a need in the field for a device that allows installation of multiple conduits to any existing fastening support system without requiring the disassembly of the rack mounted device sand allows the installation of multiple conduits to any preexisting fastening support system without the disassembly of the rack mounted devices.

### BRIEF DESCRIPTION OF DRAWINGS

The preferred embodiments of the invention will hereinafter be described in conjunction with the appended drawings provided to illustrate and not to limit the invention, in which:

FIG. 1 presents an Isometric view of an exemplary Hinged Nolt Cubed Device with attaching screws;

FIG. 2 presents an Isometric view of an exemplary Hinged Nolt Cubed Device in its pre attachment orientation;

FIG. 3 presents a Top Isometric view of the exemplary Hinged Nolt Cube Device showing threaded holes configured with a side hinge;

FIG. 4 presents a Side Isometric view of the exemplary Hinged Nolt Cube Device with the attached hinge in the operational position;

FIG. 5 presents a Bottom Isometric view of the preferred embodiment Hinged Nolt Cube Device;

FIG. 6 presents an Side Isometric view of the preferred embodiment of a Hinged Nolt Cube Device;

FIG. 7 presents an Isometric view of an alternative embodiment of a Non-Hinged Nolt Cube Device with locking screws prior to fastening;

FIG. 8 presents an Isometric view of an alternative embodiment of a Split Non-Hinged Nolt Cube device prior to installation;

FIG. 9 presents a Top View of the Non-Hinged Nolt Cube Device assembled with no threaded screws attached;

FIG. 10 presents a Side View of the Non-Hinged Nolt Cube Device assembled with no threaded screws attached;

FIG. 11 presents a Front Side View of the Non-Hinged Nolt Cube Device assembled with no screws attached;

FIG. 12 presents a bottom View of the Non-Hinged Nolt Cube Device, and;

FIG. 13 presents an Isometric view of an attachment of the Non-Hinged Nolt Cube Device to a pre-existing threaded line.

Like reference numerals refer to like parts throughout the several views of the drawings.

### DETAILED DESCRIPTION

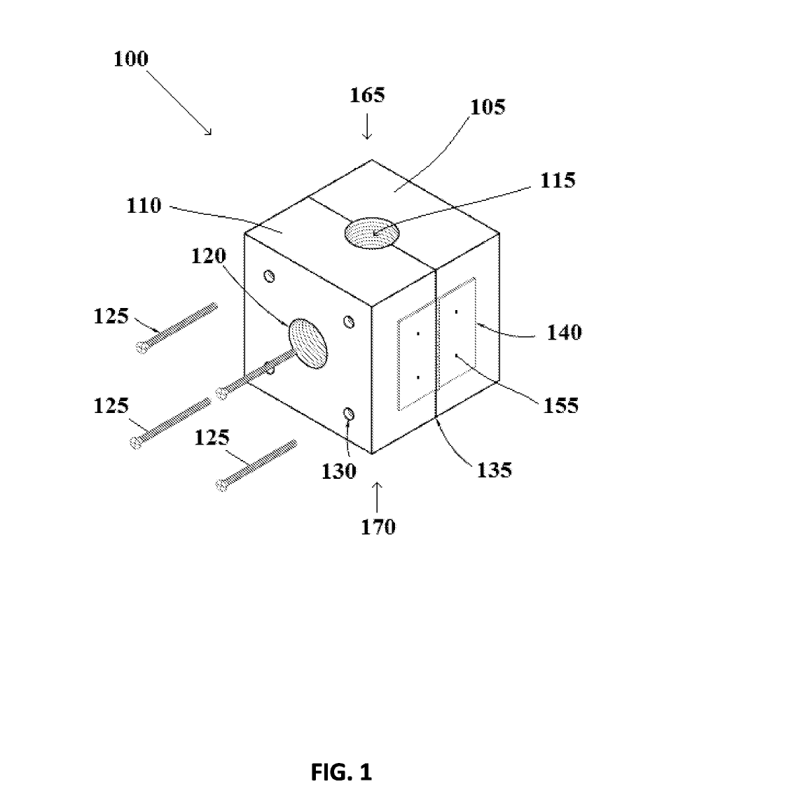

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise

With respect to FIG. 1 a hinged Nolt Threaded Cube (100) is illustrated having four locking screws (125) insertable through four Tapered hole openings (130) used to firmly attach the two halves of the Nolt Cube (100). The Cube (100) is composed of two halves, a first Sided cubed half (105) and a second side cubed half (110). When the device is fully employed the halves become one. An attached Hinge (140) is secured in place connecting both halves of the Nolt Cube (100). This permits the second end of the Nolt Cube (100) to remain in the open position and providing a means of quickly attaching to a threaded rod (not shown). A side threaded bore opening (120) and a top sided (165) threaded bore opening (115) are part of the Nolt Cube (100) structure permitting the attachment of threaded rods (not shown) to the Nolt Threaded Cube (100).

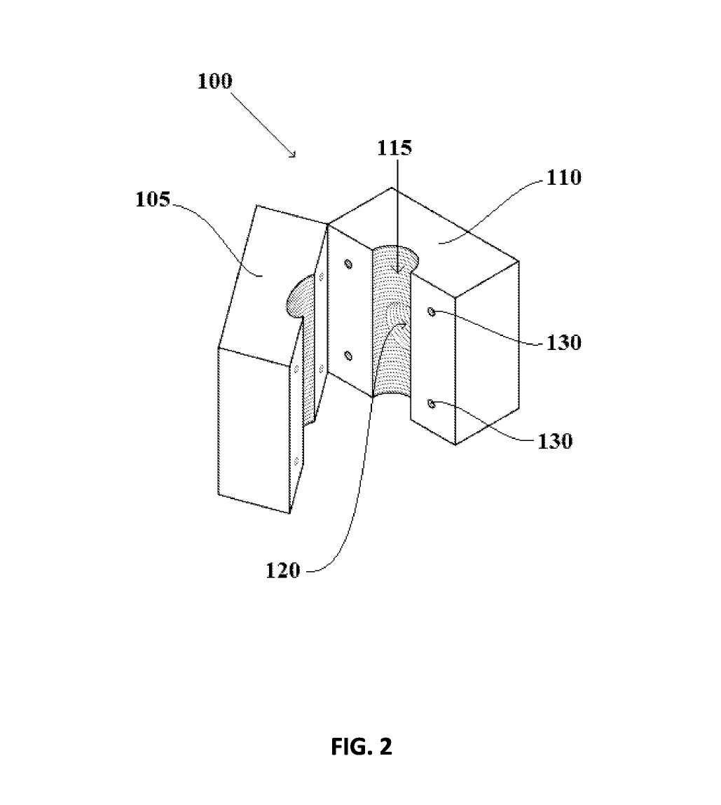

With respect to FIG. 2 a hinged Nolt Threaded Cube (100) is illustrated in its attachable position prior to installation to a pre-existing threaded rod (not shown). The First Cube body (105) and the Second Cube body (110) illustrate the Tapered Hole Openings (130) throughout.

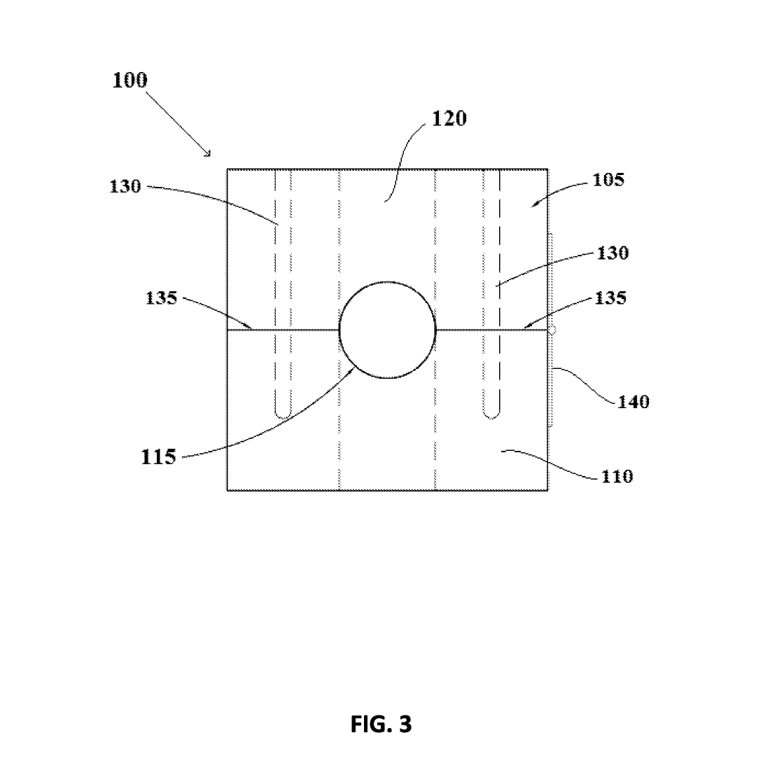

With respect to FIG. 3 a Top view of the Hinged Nolt Cube (100) is illustrated in the closed position, showing a threaded bore opening (120) and a Division line (135) whereby the two cubed halves join together. Hidden lines of the Tapered Hole Opening (130). A side view of the Attached Hinge is shown with little profile.

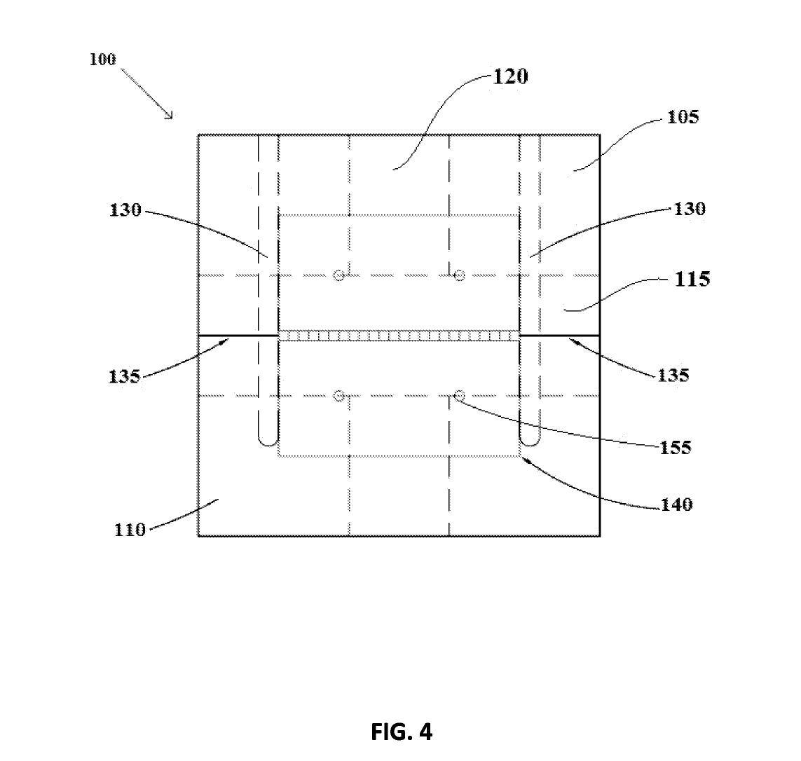

With respect to FIG. 4 a side view of the Hinged Nolt Cube (100) is illustrated with securing fasteners (155) firmly attaching the Hinged Fastener (140). The Side Threaded Bore Opening (120) is shown completely passing throughout the Nolt Cube (100).

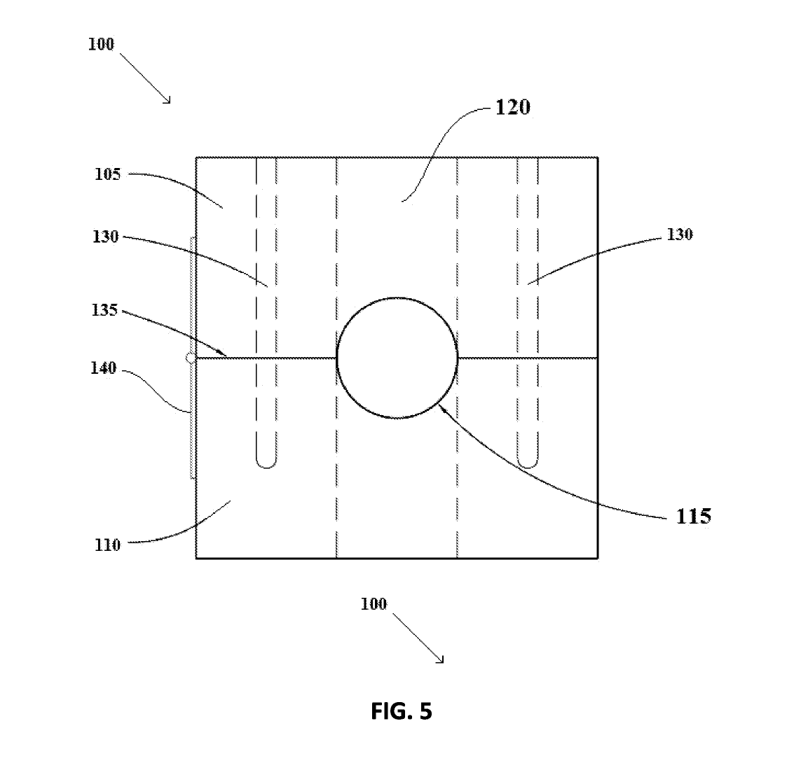

With respect to FIG. 5 a Bottom view of the Hinged Nolt Cube (100) is illustrated demonstrating a clear passage of the bottom side of the Top Threaded Bore Opening (115). Threaded Hole Openings (130) is seen extending throughout from the First Cube body (105) to the Second Cube Body (110). Hidden lines of the Side Threaded Bore Opening (120).

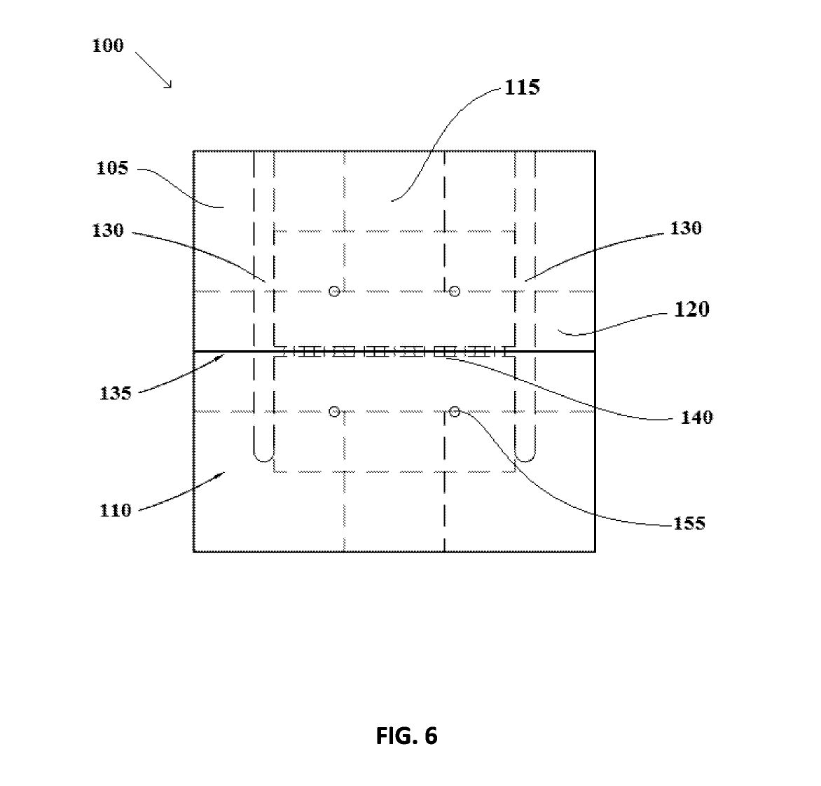

With respect to FIG. 6 a side view of the Hinged Nolt Cube (100) is illustrated whereby the side face is plane, having no tapered hole openings. Only a division line (135) is shown having any alterations to the side. This type of tight configuration is useful for attaching to threaded rods (not shown) that may not have much available working space.

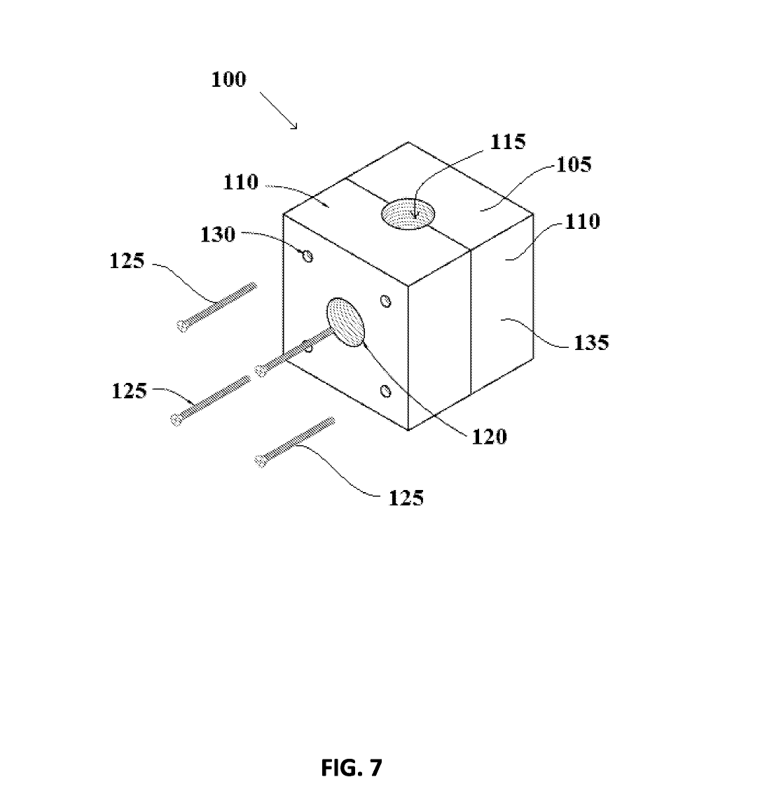

With respect to FIG. 7 a Non Hinged Nolt Cube (100) is illustrated having two sides (105) and (110) mated together, with respective locking screws (125) positioned over Tapered Hole Openings (130) used to insert the locking screws (125) for attaching the two halves of the Nolt Cube (100). A Side Threaded Bore Opening (120) and a Top Threaded Bore Opening (115) illustrate where the Threaded rods (Not shown) are attached.

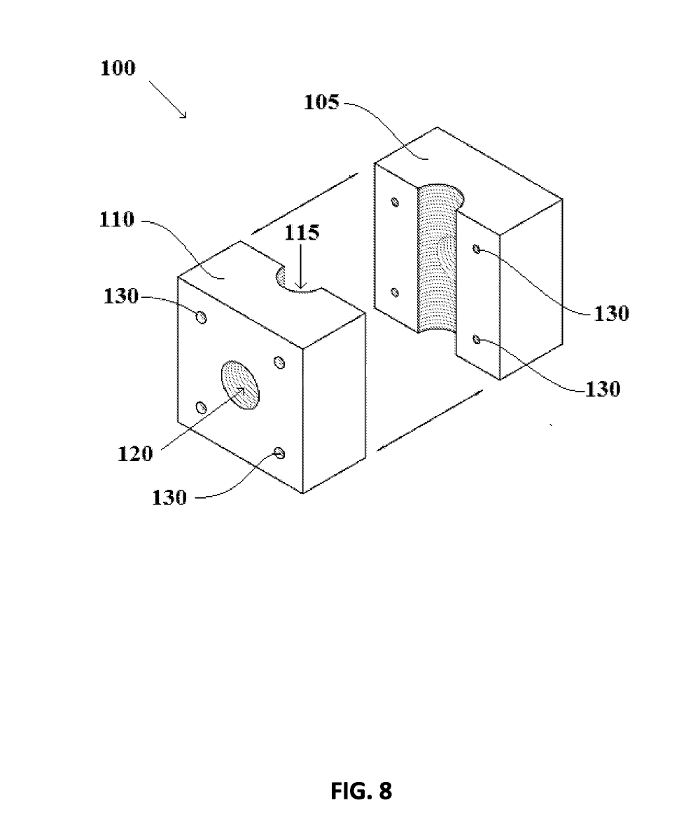

With respect to FIG. 8 a Split configuration of the Non Hinged Nolt Cube (100) is illustrated showing how the simple design is mated to each other. Tapered hole openings (130) are shown in both the First Side Cube body (105) and the Second Side Cube Body (110). The Side Threaded Bore Opening (120) is also shown in the split configuration prior to installation. This configuration allows quick installation of the Nolt Threaded Cube (100). When the two sides are mated the Top Threaded Bore Opening (115) forms a clear passage throughout.

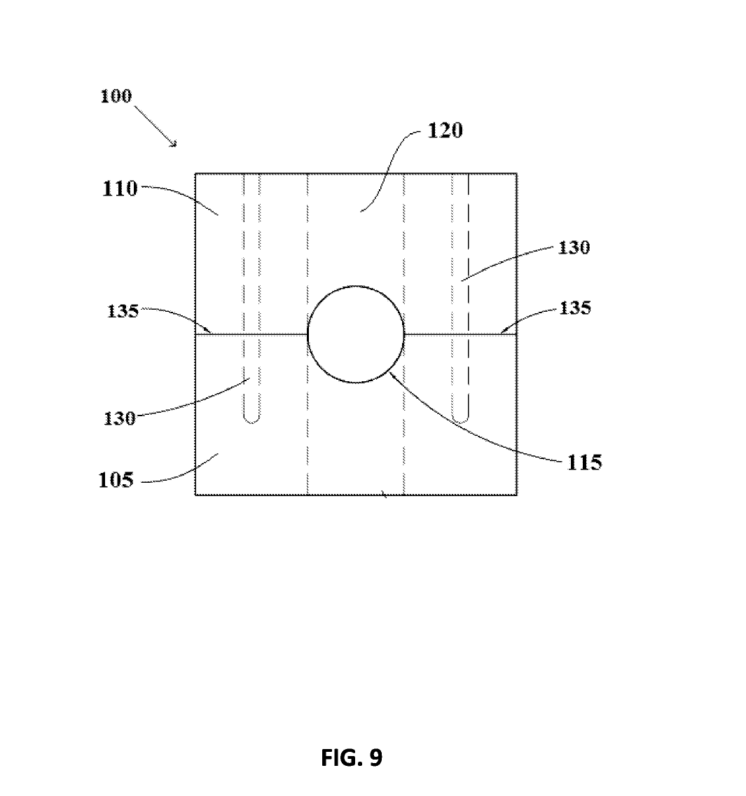

With respect to FIG. 9 a Top view of the Non Hinged Nolt Cube (100) is illustrated showing the Division Line (135) joining the First Side Cube (105) to the Second Side Cube (110). Side Threaded Bore Opening (120) depicted by hidden lines shows a passage throughout.

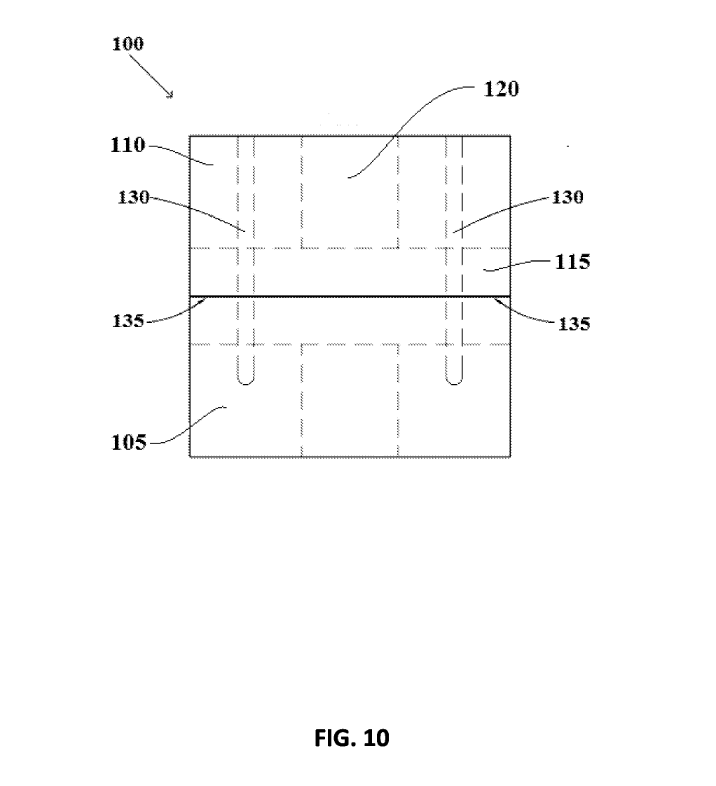

With respect to FIG. 10 a Side view of a Non Hinged Nolt Cube (100) is illustrated showing the internal cavities of the Threaded Hole Opening (130), Division Line (135). A First Side Cube Body (105) and Second Side Cube Body are shown mated together.

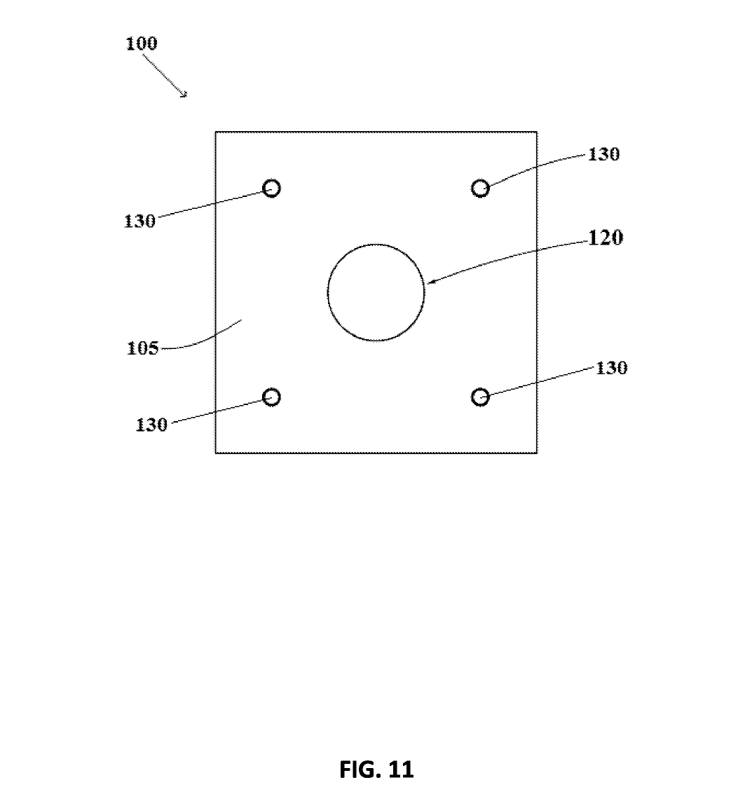

With respect to FIG. 11 a Front Side view of a Non Hinged Nolt Cube (100) is illustrated showing the Tapered Hole Openings (130) whereby the locking screws (125) not shown are inserted and used to firmly attach the Side Cubes (105, 110) to each other. Side Threaded Bore Opening (120) clearly depicts a clear passage throughout the Nolt Cube (100).

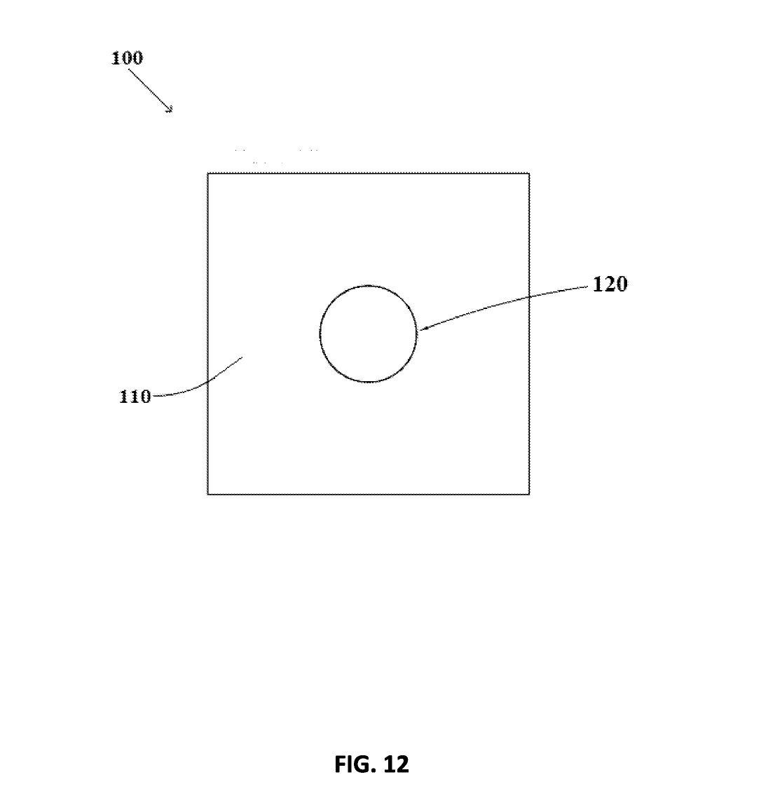

With respect to FIG. 12 a Bottom view of the Non Hinged Cube is illustrated showing the Side Threaded Bore Opening (120) passage.

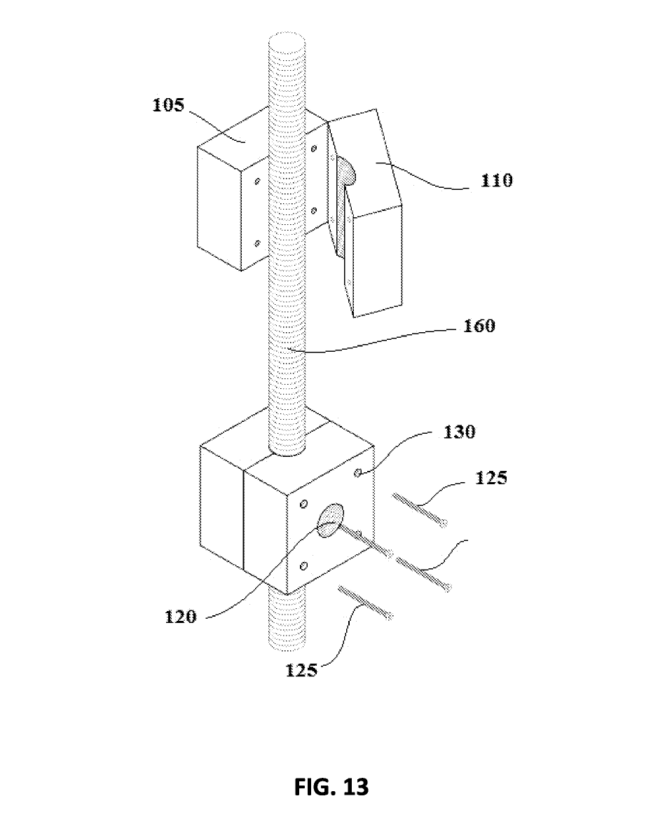

With respect to FIG. 13 an Isometric view of an attachment of the Non-Hinged Nolt Cube Device to a pre-existing threaded rod is illustrated having First Side Cube Body (105) in the open position resting on Threaded Rod (160) and the Second Side Cubed body (110) prepared to seat itself onto the Threaded Rod (160). Near the bottom of the illustration a mated Cube (105,110) are illustrated with Tapered Hole Openings (130) providing a path for Locking Screws (125) to insert themselves. Front threaded bore Opening (120) is shown not attached in this configuration but having that capability. The functionality of the Nolt Cubed Device (100) is clearly demonstrated by its ease of attachment.

As will be recognized by those of ordinary skill in the pertinent art, numerous modifications and substitutions can be made to the above-described embodiments of the present invention without departing from the scope of the invention. Accordingly, the preceding portion of this specification is to be taken in an illustrative, as opposed to a limiting sense.

1. A hinged Nolt threaded cube attachable support hardware apparatus comprising:
a split body forming an approximately first and second sides of a square cube, defining;
a threaded bore opening extending laterally from a first side to a second side throughout;
a vertically threaded bore opening extending from a top side to a bottom side throughout;
a hinged securing fastener attached both to the first side and the second side of the Nolt square cube;
two pairs of locking screws inserted through threaded hole openings for locking and securing the attachable support hardware to a threaded rod assembly; and
whereby the hinged Nolt threaded cube attachable support hardware may be detachably removed from the threaded rod assembly.

2. The apparatus of claim 1, wherein the second bore opening includes a clamping means.

3. The apparatus of claim 1, wherein the hinged securing fastener may be spring-loaded.

4. The apparatus of claim 1, wherein multiple tapered hole openings are bored through the first and second sides of the square cube, firmly securing the split body. The apparatus of claim 4, wherein the split body comprises a first split body part and a second split body part.

6. The apparatus of claim 5, wherein the tapered hole is completely bored through the first split body.

7. The apparatus of claim 5, wherein the tapered hole is partially bored through the second split body.

8. A Nolt Threaded Cube attachable support hardware apparatus comprising:
a split body forming an approximately first and second sides of a square cube, defining
a first threaded bore opening extending laterally from a first side to a second side;
a second threaded bore opening extending vertically from a top side to a bottom side throughout;
two pairs of locking screws inserted through threaded hole openings for locking and securing the attachable support hardware to a threaded rod assembly; and
whereby the Nolt threaded cube attachable support hardware may be detachably removed from the threaded rod assembly.

9. The apparatus of claim 8, wherein the second bore opening includes a clamping means.

10. The apparatus of claim 8, wherein multiple tapered hole openings are bored through the first and second sides of the square cube, firmly securing the split body.

11. The apparatus of claim 8, wherein the split body comprises a first split body part and a second split body part.

12. The apparatus of claim 11, wherein the tapered hole is completely bored through the first split body.

13. The apparatus of claim 11, wherein the tapered hole is partially bored through the second split body.

14. A method of securing a hinged Nolt threaded cube attachable support hardware apparatus to a threaded rod assembly comprising:
forming a split body on first and second sides of a square cube;
providing a threaded bore opening extending laterally from a first side to a second side throughout;
providing a second threaded bore opening extending vertically from a top side to a bottom side throughout;
attaching a hinged securing fastener to the first side and the second side of the square cube;
providing a pair of threaded holes on the first and second sides of the square cube;
inserting two pairs of locking screws through threaded hole openings for locking and securing the attachable support hardware to a threaded rod assembly; and
wherein the hinged Nolt threaded cube attachable support hardware may be detachably removed from the threaded rod assembly.

15. The method of claim 14, wherein the second bore opening is attached to a clamping means.

16. The method of claim 14, wherein multiple tapered hole openings are bored through the first and second sides of the square cube, firmly securing the split body.

17. The method of claim 14, wherein the Nolt threaded cube further comprises a first split body part and a second split body part.

18. The method of claim 17, wherein the tapered hole is completely bored through the first split body.

19. The method of claim 17, wherein the tapered hole is partially bored through the second split body.

20. A method of securing a non-hinged Nolt threaded cube attachable support hardware apparatus to a threaded rod assembly comprising:
forming a split body on a first and second side of a square cube;
providing a threaded bore opening extending laterally from a first side to a second side throughout;
providing a second threaded bore opening extending vertically from a top side to a bottom side throughout;
attaching a non-hinged securing fastener to the first side and the second side of the square cube;
providing a pair of threaded holes on the first and second sides of the square cube;
inserting two pairs of locking screws through threaded hole openings for locking and securing the attachable support hardware to a threaded rod assembly; and
wherein the non-hinged Nolt threaded cube attachable support hardware may be detachably removed from the threaded rod assembly.
